(19) United States
(12) Patent Application Publication
(10) Pub. No.: US 2019/0140260 A1
(43) Pub. Date: May 9, 2019

(54) PROCESS FOR PRODUCING PROTECTED LITHIUM ANODES FOR LITHIUM ION BATTERIES

(71) Applicants: BASF SE, Ludwigshafen am Rhein (DE); University of Waterloo, Waterloo (CA)

(72) Inventors: Linda NAZAR, Waterloo (CA); Xiao LIANG, Longhui County (CN)

(73) Assignees: BASF SE, Ludwigshafen am Rhein (DE); University of Waterloo, Waterloo, ON (CA)

(21) Appl. No.: 16/099,947

(22) PCT Filed: Apr. 12, 2017
(86) PCT No.: PCT/EP2017/058848

§ 371 Date: Nov. 8, 2018

(30) Foreign Application Priority Data
May 9, 2016 (EP) 16168678.7
Nov. 29, 2016 (EP) 16201211.6

(51) Int. Cl. H01M 4/1395; H01M 4/38; H01M 4/40; H01M 4/04; H01M 4/36; H01M 4/62; H01M 10/42

(52) U.S. Cl. CPC H01M 4/1395; H01M 4/382; H01M 4/405; H01M 2004/027; H01M 4/366; H01M 4/628; H01M 10/4235; H01M 4/0402

(57) ABSTRACT

The present invention relates to a process for producing a protected lithium anode for a lithium ion battery, wherein the protected lithium anode comprises metallic lithium and at least one alloy, and the present invention also relates to a process for producing an electrochemical cell comprising as one production step said process for producing said protected lithium anode.

The present invention relates to a process for producing a protected lithium anode for a lithium ion battery, wherein the protected lithium anode comprises metallic lithium and at least one alloy, and the present invention also relates to a process for producing an electrochemical cell comprising as one production step said process for producing said protected lithium anode.

Secondary batteries, accumulators or “rechargeable batteries” are just some embodiments by which electrical energy can be stored after generation and used when required. Owing to the significantly better energy density, there has in recent times been a move away from the water-based secondary batteries toward development of those batteries in which the charge transport in the electrical cell is accomplished by lithium ions.

The high energy density of lithium metal makes it a very promising material as the negative electrode in secondary batteries. However, lithium metal is not stable in most electrolyte solvents, leading to the formation of a poorly ionic conductive SEI on the surface immediately upon contact. Dendrites are formed during long term cycling at the zones of the thinner SEI, which will result in safety problems. Also, the rapid loss of Li and electrolyte depletion in the continuous formation/dissolution of the SEI will lead to poor cycle life. Researchers have for decades considered many strategies to stabilize the lithium anode, including using electrolyte additives to eliminate dendrite at the nucleation step, stable SEI formation relying on the reactions between lithium metal and the components of the electrolyte, dendrite suppression by artificial coating on lithium metal. Of these approaches, the artificial membranes on lithium metal are considered one of the most promising approaches.

R. S. Thompson et al., Electrochemistry Communications 13 (2011) 1369-1372 discloses the stabilization of lithium metal anodes using silane-based coatings. The substituted silane (R₃Si—) based coatings are formed from the self-terminating reaction of the R₃Si—Cl with lithium surface hydroxyl groups.

M. Ishikawa et al., J. Electroanal. Chem. 473 (1999) 279-284, describes the improvement of Li cyclability by electrochemical control of a Li metal anode interface. It was found that the addition of aluminum iodide to a mixed electrolyte reduces the charge-discharge cyclability of Li metal, while the addition of magnesium iodide improved the Li cycling efficiency in the same electrolyte.

M. Ishikawa et al., J. Power Sources 146 (2005) 199-203 discloses the pretreatment of Li metal anodes with electrolyte additives for enhancing Li cyclability. A Li sheet electrode was galvano-statically cycled only once as a pretreatment process in a binary electrolyte, propylene carbonate (PC) with dimethyl carbonate (DMC), containing Li bis(perfluoroethylsulfonyl)imide in the presence of aluminum iodide as an additive. The Li electrode, pretreated in this manner, showed a high cyclability in the subsequent cycles even after it was transferred to an electrolyte without any additives.

US 2014/0220439 A1 discloses a protected metal anode architecture comprising a metal anode and a composite protection film formed over and in direct contact with the metal anode, wherein the metal anode comprises a metal selected from the group consisting of an alkaline metal.

M. Wu et al., Electrochimica Acta 103 (2013) 199-205 discloses effects of combinatorial AlCl₃ and pyrrole on the SEI formation and electrochemical performance of Li electrodes.

Proceeding from this prior art, the object was to find a flexible and more efficient synthesis route to protected lithium anodes for lithium ion batteries. The electrochemical cells produced with these protected lithium anodes were to have a high capacity, cycling stability, efficiency and reliability, low self-discharge, good mechanical stability and low impedances.

This object is achieved by a process for producing a protected lithium anode for a lithium ion battery, wherein the protected lithium anode comprises

(A1) metallic lithium and

(A2) at least one alloy of general formula (I),

LiₓM (I)
wherein
x is a value in the range from 1 to 5, and
M is an element selected from the group of elements consisting of Al, Si, P, As, In, Bi and Zn, preferably consisting of Al, P, As, In and Zn, in particular consisting of P, As, In and Zn,
comprising the process step of
(a) contacting in total or in part the metallic surface of a body comprising metallic lithium with a liquid mixture comprising
   (C1) a compound of general formula (II),

Mⁿ⁺A^{m-}_{y} (II)
wherein
M is an element selected from the group of elements consisting of Al, Si, P, As, In, Bi and Zn, preferably consisting of Al, P, As, In and Zn, in particular consisting of P, As, In and Zn,
n is an integer from 2 to 5,
A is a monoatomic or polyatomic group, preferably a halogen, in particular Cl,
m is an integer from 1 to 3, preferably 1, and
y is equal to the ratio of n to m, and
(b) optionally removing excess liquid mixture used in process step (a) or formed lithium salts of general formula (III)

Li⁺ₘA^{m-} (III)
wherein m and A are defined as in general formula (II).

This object is also achieved by a process for producing a protected lithium anode for a lithium ion battery, wherein the protected lithium anode comprises

(A1) metallic lithium and

(A2) at least one alloy of general formula (I),

LiₓM (I)
wherein
x is a value in the range from 1 to 5, and
M is an element selected from the group of elements consisting of P, As, In, Bi and Zn, preferably consisting of P, As, In and Zn,
   comprising the process step of
(a) contacting in total or in part the metallic surface of a body comprising metallic lithium with a liquid mixture comprising
   (C1) a compound of general formula (II),

Mⁿ⁺A^{m-}_{y} (II)
wherein
M is an element selected from the group of elements consisting of P, As, In, Bi and Zn, preferably consisting of P, As, In and Zn,
n is an integer from 2 to 5,
A is a monoatomic or polyatomic group, preferably a halogen, in particular Cl,
m is an integer from 1 to 3, preferably 1, and
y is equal to the ratio of n to m, and
(b) optionally removing excess liquid mixture used in process step (a) or formed lithium salts of general formula (III)

Li⁺ₘA^{m-} (III)
wherein m and A are defined as in general formula (II).

In the context with the present invention, the electrode where during discharging a net negative charge occurs is called the anode and the electrode where during discharging a net positive charge occurs is called the cathode.

The protected lithium anodes for lithium ion batteries obtained or obtainable by the inventive process are in principle known to the person skilled in the art.

The shape of the protected lithium anodes can be varied in a wide range and depends on the shape and construction of the intended electrochemical cell.

The protected lithium anode for a lithium ion battery comprises as a first component metallic lithium, also referred to hereinafter as lithium (A1), for short, and as a second component at least one alloy of general formula LiₓM as described above, also referred to hereinafter as alloy (A2), for short.

Metallic lithium is known as such. In the context with the present invention, metallic lithium refers to lithium in the oxidation state zero. Mixtures of lithium with other metals, where said mixtures are in the form of a single phase and wherein the molar fraction of lithium in said mixtures is at least 0.6, preferably at least 0.8, more preferably at least 0.9, in particular at least 0.95 are also considered as metallic lithium in the context with the present invention.

Alloys of general formula (I),

LiₓM (I),

wherein M is an element selected from the group of elements consisting of Al, Si, P, As, In, Bi and Zn, preferably consisting of Al, P, As, In and Zn, more preferably consisting of P, As, In, Bi and Zn, in particular consisting of P, As, In and Zn, and x is a value in the range from 1 to 5, and processes to produce such alloys are known to the person skilled in the art.

In one embodiment of the present invention lithium (A1) and alloy (A2) form different and separate phases, which can be distinguished by known methods and means, such as SEM images.

The metallic lithium of the protected lithium anode obtained or obtainable by the inventive process is preferably covered in total or in part, preferably in total, with a layer of at least one, preferably one alloy of general formula (I). Depending on the structure of the anode and the presence of additional components such as current collectors in the form of wires, metal grids, metal gauze and preferably metal foils such as copper foils, alloy (A2) covers preferably at least all surfaces of the anode, which are in the finally assembled electrochemical cell in contact with an electrolyte, either an liquid electrolyte or a solid state electrolyte.

It is also possible that certain parts of the surface of lithium (A1) are covered instead of alloy (A2) by alternative compounds such as LiF, LiO, Li₃N or less defined compounds generally known as solid electrolyte interphase (SEI) which is formed by the reaction of metallic lithium with organic or inorganic compounds, which are usually components of typical liquid electrolytes.

In one embodiment of the present invention, the inventive process is characterized in that the protected lithium anode is covered in total or in part, with a layer of the at least one, preferably one alloy of general formula (I).

The thickness of the layer of alloy (A2) can be varied in a wide range depending on the conditions of the formation of alloy (A2).

In one embodiment of the present invention, the inventive process is characterized in that the thickness of the layer of the at least one, preferably one alloy of general formula (I) is in the range from 1 to 100 μm, preferably 5 to 50 μm, in particular 10 to 20 μm.

The ratio of the mass fraction of metallic lithium (A1) to the mass fraction of alloy (A2), each based on the total mass of the protected lithium anode can be varied in a wide range depending on the shape of the anode and the thickness of the layer of alloy (A2).

In one embodiment of the present invention, the inventive process is characterized in that the ratio of the mass fraction of metallic lithium (A1) to the mass fraction of alloys (A2), each based on the total mass of the protected lithium anode, is in the range from 10 to 60, preferably in the range from 15 to 45, in particular in the range from 20 to 40.

Disregarding any current collectors or wires the protected lithium anode consists for the most part of lithium (A1) and alloy (A2) and only a minor part of the protected lithium anode is assigned to alternative compounds such as above described LiF, LiO, Li₃N or the SEI, which are either formed by chance or purposely planned.

In one embodiment of the present invention, the inventive process is characterized in that the sum of the mass fractions of metallic lithium (A1) and of alloy (A2) based on the total mass of the protected lithium anode, disregarding any current collectors or wires, is in the range from 0.6 to 1, preferably in the range from 0.9 to 1, in particular in the range from 0.95 to 1.

In process step (a) of the inventive process, alloy (A2) is formed on the surface of lithium (A1) by contacting in total or in part the metallic surface of a body comprising metallic lithium with a liquid mixture comprising as a first component a compound of general formula (II) as described above, also referred to hereinafter as compound (C1), for short.

The shape or form of the body comprising metallic lithium, which is contacted with the liquid mixture in process step (a) can be varied in a wide range. Preferably the shape or form of the body comprising metallic lithium is almost identical to the shape of the final protected lithium anodes, which are used for assembling electrochemical cells.

In one embodiment of the present invention, the inventive process is characterized in that the body comprising metallic lithium is a foil.

The mass fraction of metallic lithium based on the total mass of the body comprising metallic lithium can be varied in a wide range. Preferably the body, which is contacted with the liquid mixture comprising compound (C1) consist predominantly of metallic lithium. Undesired compounds, such as corrosion products of lithium, for example with oxygen or nitrogen, are re-moved before performing process step (a).

In one embodiment of the present invention, the inventive process is characterized in that in process step (a) the mass fraction of metallic lithium based on the total mass of the body comprising metallic lithium before contacting is in the range from 0.9 up to 1, preferably in the range from 0.95 up to 1, in particular in the range from 0.98 up to 1.

The liquid mixture, which is contacted with the body comprising metallic lithium comprises compound (C1) of general formula (II) as described above as a first component. Non-limiting examples of compound (C1) are AlCl₃, AlBr₃, AlI₃, Al(BF₄)₃, Al(O-i-Prop)₃, SiCl₄, SiBr₄, PCl₅, PCl₃, AsCl₃, InCl₃, InBr₃, ZnCl₂, ZnBr₂ or ZnI₂. Preferred compounds (C1) are AlCl₃, SiCl₄, PCl₅, PCl₃, AsCl₃, InCl₃ or ZnCl₂. More preferred compounds (C1) are PCl₅, PCl₃, AsCl₃, InCl₃, InBr₃, ZnCl₂, ZnBr₂ or ZnI₂, in particular PCl₅, PCl₃, AsCl₃, InCl₃ or ZnCl₂.

In order to control the reaction between lithium and compound (C1), the body comprising metallic lithium is preferably not contacted with pure compound (C1) or a mixture of different compounds (C1) but is contacted with a mixture comprising compound (C1) and an organic solvent in order to dilute compound (C1). Suitable are organic solvents, which dissolve compound (C1) and which are much less reactive than compound (C1). Particular suitable solvents are for examples ethers, such as THF, DME or diglyme.

In one embodiment of the present invention, the inventive process is characterized in that in process step (a) the liquid mixture consists of one or more compounds of general formula (II), preferably one compound of general formula (II), and an organic solvent selected from the group consisting of ethers, preferably THF, DME, diglyme and mixtures thereof.

The concentration of compound (C1) in the liquid mixture can be varied in a wide range according to in order to control the reaction and in order to obtain the desired protected lithium anode.

In one embodiment of the present invention, the inventive process is characterized in that in process step (a) the mass fraction of the compound of general formula (II) based on the total mass of the liquid mixture is in the range from 0.01 to 0.15, preferably in the range from 0.02 to 0.12, in particular in the range from 0.05 to 0.10.

Contacting of the liquid mixture with the metallic surface of a body comprising metallic lithium is a well-known action. Preferred contacting methods in case of process step a) are selected from spin coating, casting, dip coating, spray coating, screen printing and inkjet printing, more preferably selected from dip coating and spray coating, in particular dip coating.

The formation of alloy (A2) by the reaction of lithium (A1) with compound (C1) in process step (a) is an electroless deposition or electroless plating of element M, which further instantaneously reacts with additional lithium to alloy (A1). Process step (a) can be also described as current-free precipitation of M on a lithium surface in opposite to an electrochemical deposition or electroplating.

The temperature and reaction time during process step (a) can be varied in a wide range.

In one embodiment of the present invention, the inventive process is characterized in that in process step (a) the contacting of the metallic surface of the body comprising metallic lithium with the liquid mixture is done at a temperature in the range from −108 to 70° C., preferably in the range from −50 to 60° C., in particular in the range from 25 to 50° C.

In one embodiment of the present invention, the inventive process is characterized in that in process step (a) the contacting of the metallic surface of the body comprising metallic lithium with the liquid mixture is done for a period in the range from 5 sec to 10 min, and preferably in the range from 30 sec to 2 min.

Depending on the method used for contacting the metallic surface of a body comprising metallic lithium, in part or in total, with the liquid mixture and depending on the requirements of the composition of the final protected lithium anode, it might be advantageous to remove excess liquid mixture used in process step (a) or to remove formed lithium salts of general formula (III) as described above.

Methods for removing excess liquid mixture from the surface of the protected lithium anode are known to the person skilled in the art. Excess liquid can be soaked up by an appropriate absorber, rinsed off with an inert solvent, wiped down or blown away with an inert gas such as argon.

The above described process for producing a protected lithium anode for a lithium ion battery is also part of the production of an electrochemical cell comprising said protected lithium anode produced according to the above-described process.

The present invention further provides a process for producing an electrochemical cell comprising a protected lithium anode, comprising as one production step the process for producing a protected lithium anode for a lithium ion battery as described above.

The invention is illustrated by the examples which follow, but these do not restrict the invention.

Figures in percent are each based on % by weight, unless explicitly stated otherwise.

I. Preparation of the Protected Lithium Electrode

I.1 General Method for the Preparation of the Protected Lithium Electrode

Electrode preparation was carried out in an argon-filled glove box with <1 ppm oxygen and moisture. Lithium metal foil (99.9%, Aldrich) was polished until the surface was extremely shiny. After polishing, the lithium foil was immersed in 0.167M MClₓ solution in THF for 20 seconds (M=P, Si, As, In, Zn or Bi). Upon removal from the THF solution, the excess liquid on the treated lithium foil was carefully cleaned using a Kimwipe. The foils were rinsed with THF and further dried in vacuum for 24 hours. The foil was cut into circles with 11 mm in diameter for further investigation.

It was confirmed by X-ray diffraction, that Li₃P was formed on the P protected Li; Li₁₃In₃ on In protected Li; Li₃Bi on the Bi protected Li; LiZn on the Zn protected Li; and Li₃As on the As protected Li, respectively.

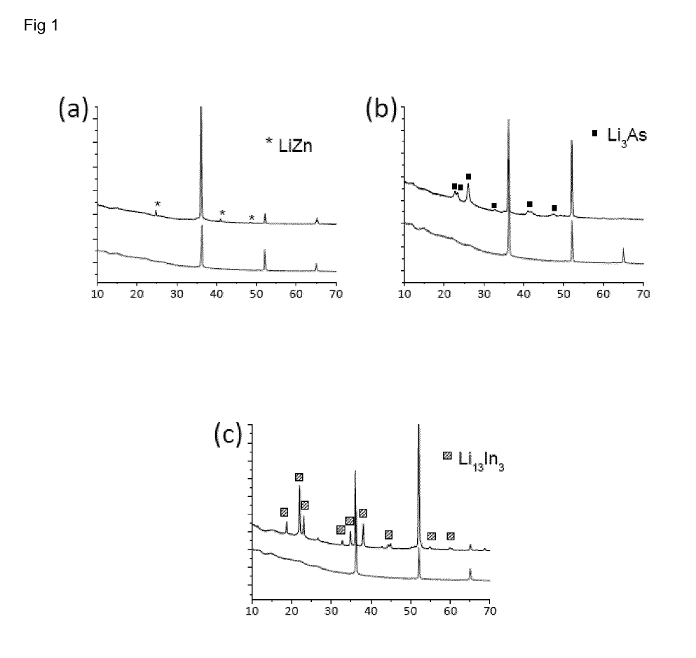

FIG. 1: X-ray diffraction patterns of (a) zinc protected lithium, (b) arsenic protected lithium, (c) indium protected lithium. The lower XRD profile in each figure was collected from fresh lithium metal. All patterns were collected within two days after the samples were prepared. In each case the x-axis shows 2 Theta, while the y-axis shows the Intensity (a.u.).

II. Testing of the Protected Lithium Electrode in Electrochemical Cells

The electrochemical studies were carried in 2032 coin cells. For the impedance and lithium plating/stripping studies, symmetric cells (fresh lithium on each side vs. protected lithium foil on each side) were assembled with 40 μL of 1M LiTFSI in DOL/DME (1:1 vol) as the electrolyte. The protocol used was 1 hour of stripping followed by 1 hour of plating with a current of 2 mA/cm². To investigate the performance of the protection with respect to the lithium metal anode, half cells were made with Li₄Ti₅O₁₂ (LTO) as the cathode. The LTO electrodes were prepared by casting a DMF slurry of Li₄Ti₅O₁₂ (Sigma-Aldrich), Super P and PVDF in a weight ratio of 8:1:1 onto the carbon coated Al foil. The cathodes were cut to disks with a diameter of 11 mm and dried at 60° C. prior to use. The areal loading of LTO was about 3 mg/cm². Approximately 40 μL of 1M LiTFSI in DOL/DME (1:1 vol) was used as the electrolyte for the LTO cells. Electrochemical impedance measurements were conducted at room temperature using a VMP-3 and a frequency range of 0.1 Hz to 100 kHz. The cycling of the half-cell was conducted on an Arbin cycler, in a voltage window between 1-2.5 V.

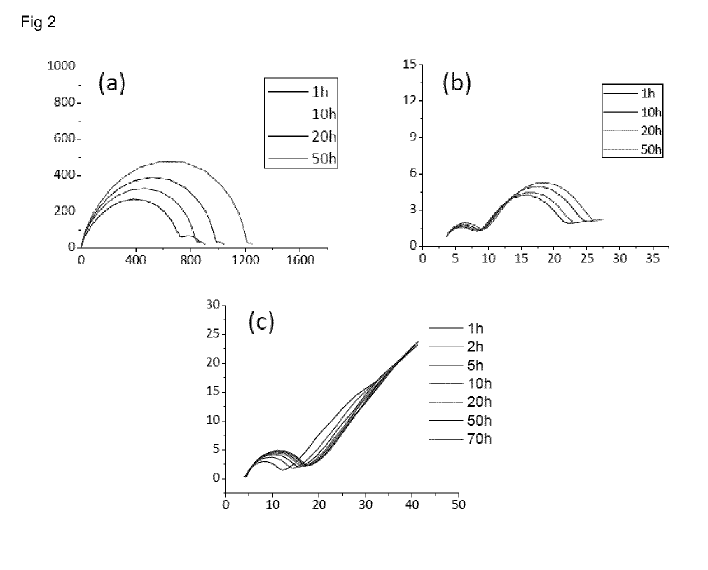

FIG. 2: Nyquist plots obtained from impedance spectroscopy for symmetric cells with different lithium metal electrodes: (a) fresh Li, (b) phosphorus protected Li, (c) indium protected Li. In each case the x-axis shows Re (Z′) Ohm, while the y-axis shows in case (a) and (b) Im (Z″) Ohm and in case (c) Z′(ohm).

1-10. (canceled)

11. A process for producing a protected lithium anode, wherein the protected lithium anode comprises
(A1) metallic lithium and
(A2) at least one alloy of formula (I),
LiₓM (I)
wherein x is in a range of 1 to 5, and
M is an element selected from the group consisting of P, As, In, Bi and Zn, and
wherein the process comprises
(a) contacting, in total or in part, a metallic surface of a body comprising metallic lithium with a liquid mixture comprising
(C1) a compound of formula (II),
Mⁿ⁺A^{m-}_{y} (II)
wherein M is an element selected from the group consisting of P, As, In, Bi and Zn,
n is an integer from 2 to 5,
A is a monoatomic or polyatomic group,
m is an integer from 1 to 3, and
y is equal to a ratio of n to m, and
(b) removing an excess of the liquid mixture or a lithium salt of formula (III)
Li⁺ₘA^{m-} (III)
wherein m and A are defined as in formula (II),
wherein the contacting has a duration of 5 sec to 2 min and
wherein a formation of (A2) by a reaction of (A1) with (C1) in (a) is an electroless deposition or electroless plating of M, which further instantaneously reacts with additional lithium to (A2).

12. The process of claim 11, wherein the protected lithium anode is covered, in total or in part, with a layer of (A2).

13. The process of claim 12, wherein the layer has a thickness in a range of 1 to 100 μm.

14. The process of claim 11, wherein a mass ratio of (A1) to (A2) is in a range of 10 to 60 based on a total mass of the protected lithium anode.

15. The process of claim 11, wherein the body comprising metallic lithium is a foil.

16. The process of claim 11, wherein a mass fraction of (A1) is in a range of 0.9 to 1 based on a total mass, before contacting, of the body comprising metallic lithium.

17. The process of claim 11, wherein a mass fraction of (C1) is in a range of 0.01 to 0.15 based on a total mass of the liquid mixture.

18. The process of claim 11, wherein the contacting occurs at a temperature in a range of −108 to 70° C.

19. A process for producing an electrochemical cell comprising a protected lithium anode, the process comprising
producing a protected lithium anode with the process of claim 11 and
incorporating the protected lithium anode in the electrochemical cell.

20. The process of claim 11, wherein a sum of a mass fraction of (A1) and a mass fraction of (A2) is in a range of 0.95 to 1 based on a total mass of the protected lithium anode, wherein the total mass disregards any current collectors or wires.
